(19) United States
(12) Patent Application Publication
(10) Pub. No.: US 2024/0119215 A1
(43) Pub. Date: Apr. 11, 2024

(54) I/O CIRCUIT, SEMICONDUCTOR DEVICE, CELL LIBRARY, AND METHOD OF DESIGNING CIRCUIT OF SEMICONDUCTOR DEVICE

(71) Applicant: ROHM CO., LTD., Kyoto (JP)

(72) Inventors: Kenichi YOSHIMURA, Kyoto (JP); Hiromitsu KIMURA, Kyoto (JP); Tomokazu OKADA, Kyoto (JP); Yuji KUROTSUCHI, Kyoto (JP)

(21) Appl. No.: 18/545,662

(22) Filed: Dec. 19, 2023

Related U.S. Application Data
(63) Continuation of application No. PCT/JP2022/023609, filed on Jun. 13, 2022.

(30) Foreign Application Priority Data
Jul. 16, 2021 (JP) 2021-117798

(51) Int. Cl. G06F 30/3953; G06F 30/38; G06F 30/392

(52) U.S. Cl. CPC G06F 30/3953; G06F 30/38; G06F 30/392; G06F 2111/20

(57) ABSTRACT

For example, an I/O circuit is formed by freely combining a plurality of kinds of standard cells included in a cell library. The plurality of kinds of standard cells include at least first standard cells and a second standard cell. The first standard cells include first protection elements and a first power line formed in a region over the first protection elements to conduct to the first protection elements. The second standard cell includes a second protection element formed in a layout identical with that of the first protection elements, and a second power line formed in a region over the second protection element to conduct to the second protection element while being isolated from the first power line.

### CROSS-REFERENCE TO RELATED APPLICATIONS

This nonprovisional application is a continuation application of International Patent Application No. PCT/JP2022/023609 filed on Jun. 13, 2022, which claims priority Japanese Patent Application No. 2021-117798 filed on Jul. 16, 2021, the entire contents of which are hereby incorporated by reference.

### TECHNICAL FIELD

The invention disclosed herein relates to an I/O (input/output) circuit, a semiconductor device, a cell library, and a method of designing the circuit of a semiconductor device.

### BACKGROUND ART

There is conventionally known a method of designing the circuit of a semiconductor device by freely combining a plurality of kinds of standard cells included in a cell library.

An example of known technology related to what has just been mentioned is seen in Patent Documents 1 and 2 identified below.

### CITATION LIST

### Patent Literature

Patent Document 1: JP-A-2010-28126
Patent Document 2: JP-A-2010-192932

### BRIEF DESCRIPTION OF DRAWINGS

FIG. 1 is a diagram showing one configuration example of an application using a semiconductor device.

FIG. 2 is a diagram showing an I/O circuit of a first comparative example.

FIG. 3 is a diagram showing an I/O circuit of a second comparative example.

FIG. 4 is a diagram showing an I/O circuit of a third comparative example.

FIG. 5 is a diagram showing an I/O circuit according to a first embodiment.

FIG. 6 is a diagram showing an I/O circuit according to a second embodiment.

FIG. 7 is a diagram showing an I/O circuit according to a third embodiment.

### DESCRIPTION OF EMBODIMENTS

<Semiconductor Device (Application)>

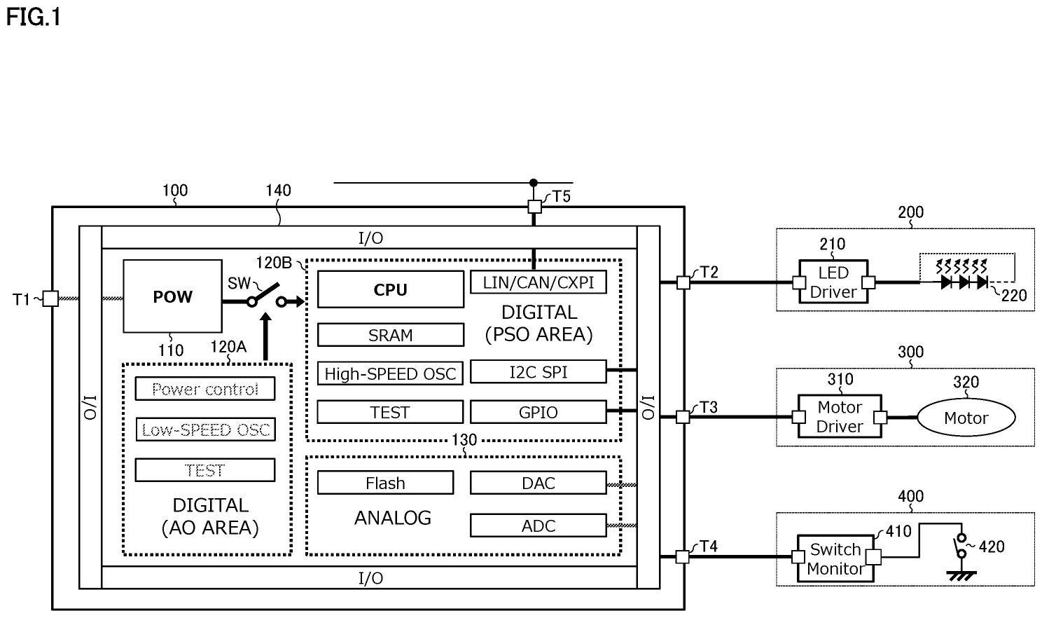

FIG. 1 is a diagram showing one configuration example of an application using a semiconductor device. The semiconductor device 100 in this configuration example is a vehicle-mounted integrated communication IC that receives instructions via a vehicle onboard network to control a controller (such as an ECU [electronic control unit]) incorporated in various terminal devices. The semiconductor device 100 includes, as a means for establishing electrical connection with outside the device, a plurality of external terminals T1 to T5.

The external terminal T1 is a power terminal for receiving electric power from a battery. The external terminals T2 to T4 are communication terminals for performing signal exchange with various terminal devices (for example, an LED [light emitting diode] lighting device 200, a motor device 300, and a switch device 400) by any protocol (such as an I2C [inter-integrated circuit], an SPI [serial peripheral interface], a GPIO [general-purpose input/output], or a PWM [pulse width modulation]). The external terminal T5 is a network terminal connected to any on-board network (such as LIN [local interconnect network], CXPI [clock extension peripheral interface], or CAN [controller area network].

The LED lighting device 200 includes an LED 210 and an LED driver IC 220 that controls the light emission of the LED 210 in response to instructions from the semiconductor device 100.

The motor device 300 includes a motor 310 and a motor driver IC 320 that controls the rotation of the motor 310 in response to instructions from the semiconductor device 100.

The switch device 400 includes a switch 410 and a switch monitor IC420 that monitors the on/off state of the switch 410 to notify the semiconductor device 100 of the monitoring result.

With reference still to FIG. 1, the internal configuration of the semiconductor device 100 will be described. The semiconductor device 100 in this configuration example includes a power supply circuit 110, a digital circuit 120 (digital circuits 120A and 120B in FIG. 1), an analog circuit 130, an I/O circuit 140, and a power switch SW.

The power supply circuit 110 generates from a battery voltage fed to the external terminal T1 a predetermined internal supply voltage and supplies it to different blocks in the semiconductor device 100. The circuit blocks integrated in the semiconductor device 100 belong to either an AO (always on) region or a PSO (partially shut-off) region. The AO region is a region that is always kept in a power-on state regardless of whether the semiconductor device 100 is in a normal mode (corresponding to a first operation mode) or in a stand-by mode (that is, a second operation mode). On the other hand, the PSO region is arranged downstream of the power switch SW, and it is in a power-on state when the semiconductor device 100 is in the normal mode (with SW on) and is in a power-off state when the semiconductor device 100 is in the stand-by mode (with SW off). Needless to say, the power supply circuit 110 is implemented in the AO region.

The digital circuit 120A is one of the circuit blocks implemented in the AO region and includes a power controller, a low-speed oscillator, some test circuits, and the like.

The digital circuit 120B is one of the circuit blocks implemented in the PSO region and includes a CPU (central processing unit), an SRAM (static random-access memory), a high-speed oscillator, other test circuits, a LIN/CAN/CXPI interface, an I2C/SPI interface, a GPIO interface, and the like.

The analog circuit 130 includes a flash memory, a DAC (digital-to-analog converter), an ADC (analog-to-digital), and the like. The analog circuit 130 may be implemented in the AO region or in the PSO region.

The I/O circuit 140 is a front-end circuit that performs signal exchange between the external terminals T1 to T5 and internal circuits (the power supply circuit 110, the digital circuits 120A and 120B, and the analog circuit 130). The I/O circuit 140 may be arranged along the four sides of the semiconductor device 100 so as to surround the just-mentioned internal circuit as seen in a plan view of the semiconductor device 100.

The power switch SW, based on instructions from the digital circuit 120A (in particular, the power controller), switches between conducting and cut-off states the power supplying path from the power supply circuit 110 to the PSO region.

### I/O Circuit (First Comparative Example)

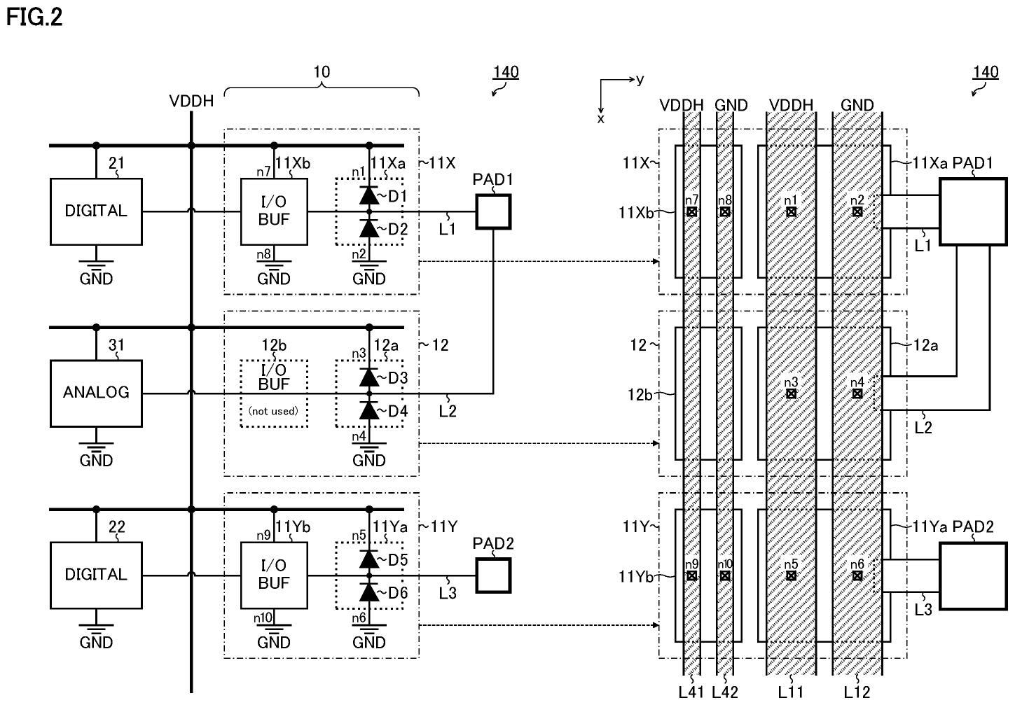

FIG. 2 is a diagram showing a first comparative example (a common configuration example to be compared with each of the first to third embodiments described later) of the I/O circuit 140. At left in FIG. 2 is shown a schematic circuit diagram of the I/O circuit 140. On the other hand, at right in FIG. 2 is shown a schematic circuit layout of the I/O circuit 140 as seen on the xy plane.

The I/O circuit 140 of the first comparative example is formed by freely combining a plurality of kinds of standard cells included in an I/O cell library 10. The I/O cell library 10 is read from a circuit design program executed on a computer and it can be understood as a kind of circuit design database. The shapes and the layouts of the plurality of kinds of standard cells mentioned above are normalized so that, even if one standard cell is replaced with another standard cell, no modification needs to be made to the standard cells arranged around it.

A method of designing the circuit of the semiconductor device 100 (in particular, the I/O circuit 140) using the I/O cell library 10 will be described briefly. Performed first is a step of selecting, arranging, and freely combining a plurality of kinds of standard cells included in the I/O cell library 10. Performed next is a step of laying power lines, signal lines, and the like so as to connect the plurality of freely combined kinds of standard cells to other circuit blocks. Performed last is a step of verifying whether the designed circuit fulfills desired conditions (such as electrical characteristics).

In this way, designing the circuit of the semiconductor device 100 using the I/O cell library 10 helps reduce the burden on a circuit designer and reduce design errors.

In terms of what is shown in FIG. 2, the I/O circuit 140 in the first comparative example is formed by combining, as the plurality of standard cells mentioned above, I/O cells 11X and 11Y of the same kind and an I/O cell 12 of another kind.

The I/O cell 11X includes a protection element 11Xa and an I/O buffer 11Xb. The I/O cell 12 includes a protection element 12a and an I/O buffer 12b. The I/O cell 11Y includes a protection element 11Ya and an I/O buffer 11Yb.

The protection element 11Xa includes electrostatic protection diodes D1 and D2. The cathode of the electrostatic protection diode D1 (corresponding to a node n1) is connected to a power line L11 that is fed with a first supply voltage VDDH. The anode of the electrostatic protection diode D1 and the cathode of the electrostatic protection diode D2 are both connected to a pad PAD1 via a wiring L1. The anode of the electrostatic protection diode D2 (corresponding to a node n2) is connected to a power line L12 that is fed with a reference supply voltage GND (ground voltage).

The protection element 12a includes electrostatic protection diodes D3 and D4. The cathode of the electrostatic protection diode D3 (corresponding to a node n3) is connected to the power line L11 that is fed with the first supply voltage VDDH. The anode of the electrostatic protection diode D3 and the cathode of the electrostatic protection diode D4 are both connected to the pad PAD1 via a wiring L2. The anode of the electrostatic protection diode D4 (corresponding to a node n4) is connected to the power line L12 that is fed with the reference supply voltage GND.

The protection element 11Ya includes electrostatic protection diodes D5 and D6. The cathode of the electrostatic protection diode D5 (corresponding to a node n5) is connected to the power line L11 that is fed with the first supply voltage VDDH. The anode of the electrostatic protection diode D5 and the cathode of the electrostatic protection diode D6 are both connected to a pad PAD2 via a wiring L3. The anode of the electrostatic protection diode D6 (corresponding to a node n6) is connected to the power line L12 that is fed with the reference supply voltage GND.

The I/O buffer 11Xb is an input buffer, an output buffer, or an input/output buffer formed so as to be connected to the protection element 11Xa. The power node of the I/O buffer 11Xb (corresponding to a node n7) is connected to a power line L41 that is fed with the first supply voltage VDDH. The ground node of the I/O buffer 11Xb (corresponding to a node n8) is connected to a power line L42 that is fed with the reference supply voltage GND.

The I/O buffer 12b is an input buffer, an output buffer, or an input/output buffer formed so as to be connected to the protection element 12a. Here, the I/O buffer 12b included in the I/O cell 12 is left unused, and the protection element 12a and the analog circuit 31 are directly connected together. Thus, the power node and the ground node of the I/O buffer 12b are both open.

The I/O buffer 11Yb is an input buffer, an output buffer, or an input/output buffer formed so as to be connected to the protection element 11Ya. The power node of the I/O buffer 11Yb (corresponding to a node n9) is connected to the power line L41 that is fed with the first supply voltage VDDH. The ground node of the I/O buffer 11Yb (corresponding to a node n10) is connected to the power line L42 that is fed with the reference supply voltage GND.

In this way, the I/O cells 11X and 12 are both connected to the pad PAD1. Thus, in the semiconductor device 100, it is possible to use the pad PAD1 differently depending on its use.

The digital circuit 21 is connected to the pad PAD1 via the I/O cell 11X and operates by being fed with the first supply voltage VDDH.

The digital circuit 22 is connected to the pad PAD2 via the I/O cell 11Y and operates by being fed with the first supply voltage VDDH.

The analog circuit 31 is connected to the pad PAD1 via the I/O cell 12 and operates by being fed with the first supply voltage VDDH.

The digital circuits 21 and 22 described above can be understood to belong to either the digital circuit 120A or 120B (FIG. 1) described previously. The analog circuit 31 can be understood to belong to the analog circuit 130 (FIG. 1) described previously.

The I/O cells 11X, 11Y, and 12 are, as seen on the xy plane, formed in an identical rectangular shape and the protection elements 11Xa, 11Ya, and 12a included respectively in them are arranged in an identical layout. Also the I/O buffers 11Xb, 11Yb, and 12b are arranged in an identical layout.

The I/O cells 11X, 11Y, and 12 are arrayed, as seen on the xy plane, in the order of 11X, 12, and 11Y from top down in the diagram along a first direction x (up-down direction on the plane of the diagram).

The power line L11 (the VDDH feed line for the protection elements) is laid along the first direction x so as to pass through regions over the protection elements 11Xa, 12a, and 11Ya in this order, and conducts via the nodes n1, n3, and n5 (through contact holes, vias, or the like) to the protection elements 11Xa, 12a, and 11Ya respectively.

Likewise, the power line L12 (the GND feed line for the protection elements) is laid parallel to the power line L11 along the first direction x so as to pass through regions over the protection elements 11Xa, 12a, and 11Ya in this order, and conducts via the nodes n2, n4, and n6 (through contact holes, vias, or the like) to the protection elements 11Xa, 12a, and 11Ya respectively.

The power line L41 (the VDDH feed line for the I/O buffers) is laid along the first direction x so as to pass through regions over the I/O buffers 11Xb, 12b, and 11Yb in this order, and conducts via the nodes n7 and n9 (through contact holes, vias, or the like) to the protection elements 11Xb and 11Yb respectively.

Likewise, the power line L42 (the GND feed line for the I/O buffers) is laid parallel to the power line L41 along the first direction x so as to pass through regions over the I/O buffers 11Xb, 12b, and 11Yb in this order, and conducts via the nodes n8 and n10 (through contact holes, vias, or the like) to the I/O buffers 11Xb and 11Yb respectively.

On the other hand, the wirings L1 to L3 are laid along a second direction y (left-right direction on the plane of the diagram) perpendicular to the first direction x.

Here, a condition is to be met: the circuits directly connected to the protection elements 11Xa, 11Ya, and 12a should operate using the same supply voltages as those fed to the protection elements 11Xa, 11Ya, and 12a respectively.

In terms of what is shown in the diagram, the protection element 11Xa and the I/O buffer 11Xb directly connected to the protection element 11Xa are both fed with the first supply voltage VDDH. Likewise, the protection element 12a and the analog circuit 31 directly connected to the protection element 12a (the unused I/O buffer 12b is ignored) are both fed with the first supply voltage VDDH. The protection element 11Ya and the I/O buffer 11Yb directly connected to the protection element 11Ya are both fed with the first supply voltage VDDH. Thus, the condition mentioned above is fulfilled.

### I/O Circuit (Second Comparative Example)

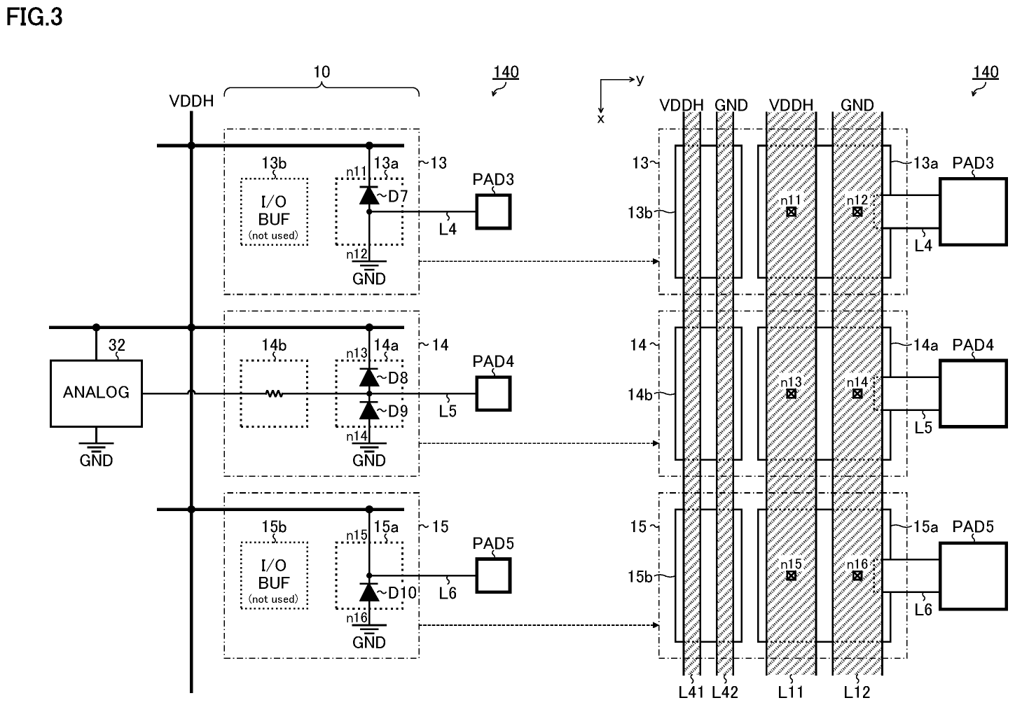

FIG. 3 is a diagram showing a second comparative example (a common configuration example to be compared with each of the first to third embodiments described later) of the I/O circuit 140. As in FIG. 2 referred to previously, at left in FIG. 3 is shown a schematic circuit diagram of the I/O circuit 140. On the other hand, at right in FIG. 3 is shown a schematic circuit layout of the I/O circuit 140 as seen on the xy plane.

The I/O circuit 140 of the second comparative example is formed by combining, as a plurality of kinds of standard cells included in the I/O cell library 10, I/O cells 13, 14, and 15.

The I/O cell 13 includes a protection element 13a and an I/O buffer 13b. The I/O cell 14 includes a protection element 14a and a limiting resistor 14b. The I/O cell 15 includes a protection element 15a and an I/O buffer 15b.

The protection element 13a includes an electrostatic protection diode D7. The cathode of the electrostatic protection diode D7 (corresponding to a node n11) is connected to the power line L11 that is fed with the first supply voltage VDDH. The anode of the electrostatic protection diode D7 (corresponding to a node n12) is connected to a pad PAD3 via a wiring L4. The pad PAD3 corresponds to a GND pad that is fed with the reference supply voltage GND (ground voltage).

The protection element 14a includes electrostatic protection diodes D8 and D9. The cathode of the electrostatic protection diode D8 (corresponding to a node n13) is connected to the power line L11 that is fed with the first supply voltage VDDH. The anode of the electrostatic protection diode D8 and the cathode of the electrostatic protection diode D9 are both connected to a pad PAD4 via a wiring L5. The anode of the electrostatic protection diode D9 (corresponding to a node n14) is connected to the power line L12 that is fed with the reference supply voltage GND.

The protection element 15a includes an electrostatic protection diode D10. The cathode of the electrostatic protection diode D10 (corresponding to a node n15) is connected to a pad PAD5 via a wiring L6. The pad PAD5 corresponds to a power pad that is fed with the first supply voltage VDDH. The anode of the electrostatic protection diode D10 (corresponding to a node n16) is connected to the power line L12 that is fed with the reference supply voltage GND.

The I/O buffer 13b is an input buffer, an output buffer, or an input/output buffer formed so as to be connected to the protection element 13a. Here, the I/O buffer 13b included in the I/O cell 13 is left unused. Thus, the power node and the ground node of the I/O buffer 13b are both open.

The limiting resistor 14b is a resistive element formed so as to be connected to the protection element 14a.

The I/O buffer 15b is an input buffer, an output buffer, or an input/output buffer formed so as to be connected to the protection element 15a. Here, the I/O buffer 15b included in the I/O cell 15 is left unused. Thus, the power node and the ground node of the I/O buffer 15b are both open.

The analog circuit 32 is connected to the pad PAD4 via the I/O cell 14 and operates by being fed with the first supply voltage VDDH. The analog circuit 32 can be understood to belong to the analog circuit 130 (FIG. 1) described previously.

The I/O cells 13 to 15 are, as seen on the xy plane, formed in an identical rectangular shape and the protection elements 13a to 15a included respectively in them are arranged in an identical layout. Also the I/O buffer 13b, the limiting resistor 14b, and the I/O buffer 15b are arranged in an identical layout.

The I/O cells 13 to 15 are arrayed, as seen on the xy plane, in the order of 13, 14, and 15 from top down in the diagram along a first direction x (up-down direction on the plane of the diagram).

The power line L11 (VDDH feed line for the protection elements) is laid along the first direction x so as to pass through regions over the protection elements 13a, 14a, and 15a in this order, and conducts via the nodes n11, n13, and n15 (through contact holes, vias, or the like) to the protection elements 13a, 14a, and 15a respectively.

Likewise, the power line L12 (GND feed line for the protection elements) is laid parallel to the power line L11 along the first direction x so as to pass through regions over the protection elements 13a, 14a, and 15a in this order, and conducts via the nodes n12, n14, and n16 (through contact holes, vias, or the like) to the protection elements 13a, 14a, and 15a respectively.

The power line L41 (the VDDH feed line for the I/O buffers) is laid along the first direction x so as to pass through regions over the I/O buffer 13b, the limiting resistor 14b, and the I/O buffer 15b in this order. Here, the power line L41 conducts to none of the I/O buffer 13b, the limiting resistor 14b, and the I/O buffer 15b.

Likewise, the power line L42 (the GND feed line for the I/O buffer) is laid parallel to the power line L41 along the first direction x so as to pass through regions over the I/O buffer 13b, the limiting resistor 14b, and the I/O buffer 15b in this order. Here, the power line L42, like the power line L41 described previously, conducts to none of the I/O buffer 13b, the limiting resistor 14b, and the I/O buffer 15b.

On the other hand, the wirings L4 to L6 are laid along a second direction y (left-right direction on the plane of the diagram) perpendicular to the first direction x.

In this way, by freely combining a plurality of kinds of standard cells included in the I/O cell library 10 such as, for example, the I/O cells 11X and 11Y in the first comparative example (FIG. 2) or the I/O cells 12 to 15 in the second comparative example (FIG. 3), it is possible to design a variety of I/O circuits 140.

### I/O Circuit (Third Comparative Example)

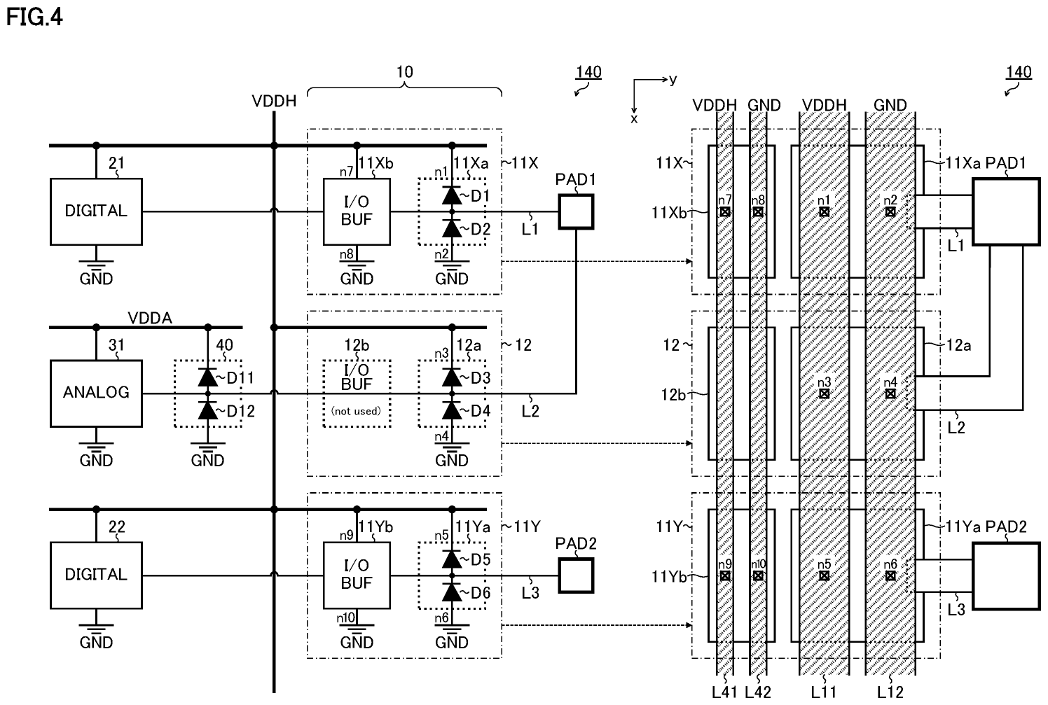

FIG. 4 is a diagram showing a third comparative example (a common configuration example to be compared with the first to third embodiments described later) of the I/O circuit 140. As in FIGS. 2 and 3 referred to previously, at left in FIG. 4 is shown a schematic circuit diagram of the I/O circuit 140. On the other hand, at right in FIG. 4 is shown a schematic circuit layout of the I/O circuit 140 as seen on the xy plane.

The third comparative example has basically a similar configuration to the first comparative example (FIG. 2) described previously. Here, when a single pad PAD1 is shared between the digital circuit 21 and the analog circuit 31 (in particular, a circuit such as an ADC that needs to be high-accuracy), it is preferable that separate power supply systems be used between the digital circuits 21 and 22 and the analog circuit 31 to prevent power supply noise caused by the operation of the digital circuits 21 and 22 from affecting the analog circuit 31.

In terms of what is shown in FIG. 4, the digital circuits 21 and 22 (corresponding to a first internal circuit) are fed with the first supply voltage VDDH described previously. On the other hand, the analog circuit 31 (corresponding to a second internal circuit) is fed with a second supply voltage VDDA across a system different from that of the first supply voltage VDDH.

With this configuration, different supply voltages, namely the first supply voltage VDDH and the second supply voltage VDDA, are fed respectively to the protection element 12a described previously and to the analog circuit 31 (the unused I/O buffer 12b is ignored) that is directly connected to the protection element 12a. That is, the above-mentioned condition that the circuit directly connected to the protection element 12a should operate using the same supply voltage as that fed to the protection element 12a cannot be met.

Thus, with the I/O cell library 10 described so far, it is not possible to achieve a protection system required when, for example, a single pad PAD1 is shared between the digital circuit 21 and the analog circuit 31 that use different supply voltages.

Thus, in the third comparative example, it is necessary to provide outside the I/O circuit 140 a separate protection element 40 (diodes D11 and D12) that is fed with the second supply voltage VDDA common to the analog circuit 32. This results in an increased circuit area for the protection element 40 and a complicated chip design.

In view of the problems mentioned above, presented below will be a novel I/O cell library 10 with which, even when, for example, a single pad PAD1 is shared between the digital circuit 21 and the analog circuit 31 that use different supply voltages, it is possible to form the I/O circuit 140 with a desired protection system by combining standard cells.

### I/O Circuit (First Embodiment)

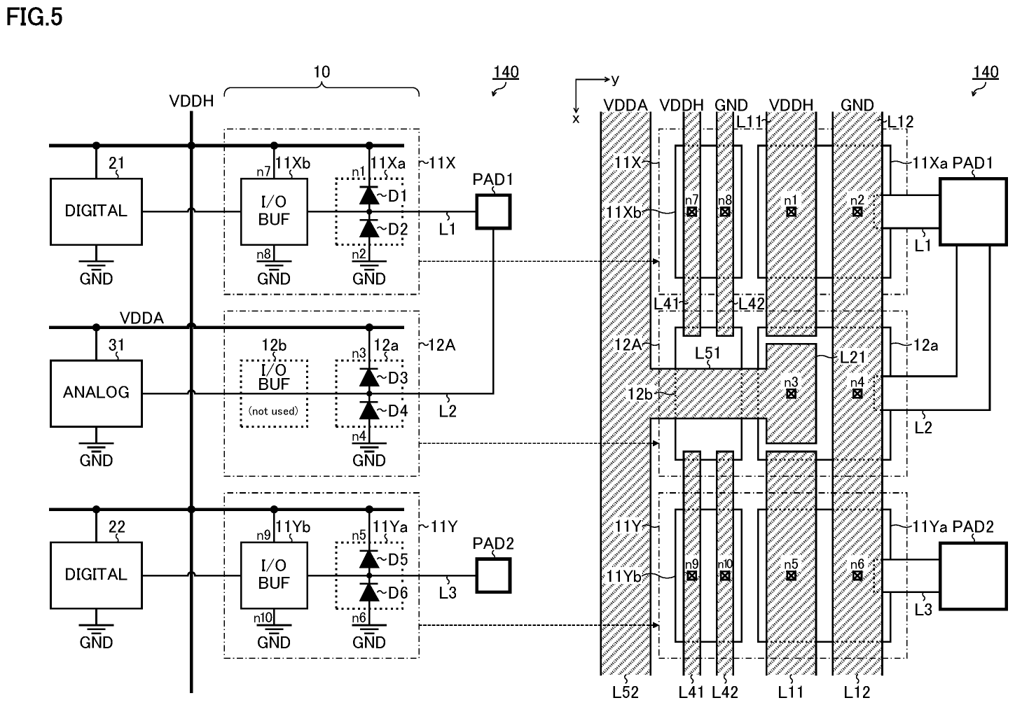

FIG. 5 is a diagram showing an I/O circuit 140 according to a first embodiment. As in FIGS. 2 to 4 referred to previously, at left in FIG. 5 is shown a schematic circuit diagram of the I/O circuit 140. On the other hand, at right in FIG. 5 is shown a schematic circuit layout of the I/O circuit 140 as seen on the xy plane.

The I/O circuit 140 of the first embodiment, while being based on the first comparative example (FIG. 2) described previously, is formed using a novel I/O cell 12A in place of the I/O cell 12 described previously. That is, the I/O cell library 10 used in a circuit design for the I/O circuit 140 includes, as a plurality of types of standard cells, existing I/O cells 11X and 11Y (each corresponding to a first standard cell) and a novel I/O cell 12A (corresponding to a second standard cell). Needless to say, the I/O cell library 10 may include any other standard cells (such as I/O cells 12 to 15 described previously).

The I/O cell 12A, like the I/O cell 12 described previously, includes a protection element 12a and an I/O buffer 12b. The I/O cells 11X, 11Y, and 12A are, as seen on the xy plane, formed in an identical rectangular shape and the protection elements 11Xa, 11Ya, and 12a included respectively in them are arranged in an identical layout. Also the I/O buffers 11Xb, 11Yb, and 12b are arranged in an identical layout. In this regard, there is no difference from the first comparative example (FIG. 2) described previously, but the I/O cell 12A includes, as its distinctive circuit elements, power lines L21 and L51.

The power line L21 (corresponding to a second power line) is formed, while being isolated from the power lines L11 and L12 (corresponding to a first power line) described previously, in a region over the protection element 12a so as to conduct to the protection element 12a via the node n3 described previously. In terms of what is shown in FIG. 5, in a region over the protection element 12a, the power line L11 described previously is partly removed, and the power line L21 is laid in the vacant region.

The power line L51 (corresponding to a fifth power line) is formed, while being isolated from the power lines L41 and L42 (corresponding to a fourth power line), in a region over the I/O buffer 12b so as to conduct to the power line L21 described above. In terms of what is shown in FIG. 5, in a region over the I/O buffer 12b, the power lines L41 and L42 described previously are partly removed, and the power line L51 is laid in the vacant region. The power line L51 extends up to an end part (left end in FIG. 5) of the I/O cell 12A along the second direction y (left-right direction on the plane of the diagram) and, outside the I/O circuit 140, conducts to the power line L52 that is fed with the second supply voltage VDDA.

In this way, in the I/O cell 12A, as a wiring region for the power line L51 necessary to change the power connection destination of the protection element 12a from the first supply voltage VDDH, a region over the I/O buffer 12b is used. Thus, it is possible to select the power connection destination of the protection element 12a without changing the circuit configurations and layouts of the protection element 12a and the I/O buffer 12b. Specifically, with the I/O circuit 140 of the first embodiment, it is possible to feed the protection element 12a with the second supply voltage VDDA different from the first supply voltage VDDH.

Accordingly, it is possible to feed both the protection element 12a and the analog circuit 31 with the common second supply voltage VDDA. Thus, in a case where, for example, a single pad PAD1 is shared between the digital circuit 21 and the analog circuit 31 that use different supply voltages, the above-mentioned condition that the circuit directly connected to the protection element 12a should operate using the same supply voltage as that fed to the protection element 12a can be met.

In particular, with the novel I/O cell 12A, unlike the third comparative example (FIG. 4) described previously, no separate protection element 40 (FIG. 4) is necessary. That is, with the I/O circuit 140 of the first embodiment, it is possible, while keeping its area comparable with that of the I/O circuit 140 (FIG. 2) of the first comparative example that uses a single power supply system, to separate the power supply system of the protection element 12a connected to the analog circuit 31 from that of the protection elements 11Xa and 11Ya.

Here, the I/O buffer 12b in the I/O cell 12A is unusable. This however is a minor disadvantage because, when the I/O cell 12A is connected to the analog circuit 31, the I/O buffer 12b is unnecessary (see FIG. 2) in the first place. When the I/O cell 12A is connected to a digital circuit, a separate I/O buffer can be provided in the digital circuit. An I/O buffer generally requires an area smaller than a protection element; thus, compared to the third comparative example (see FIG. 4), which requires a separate protection element 40, it is still possible to suppress an increase in the area.

### I/O Circuit (Second Embodiment)

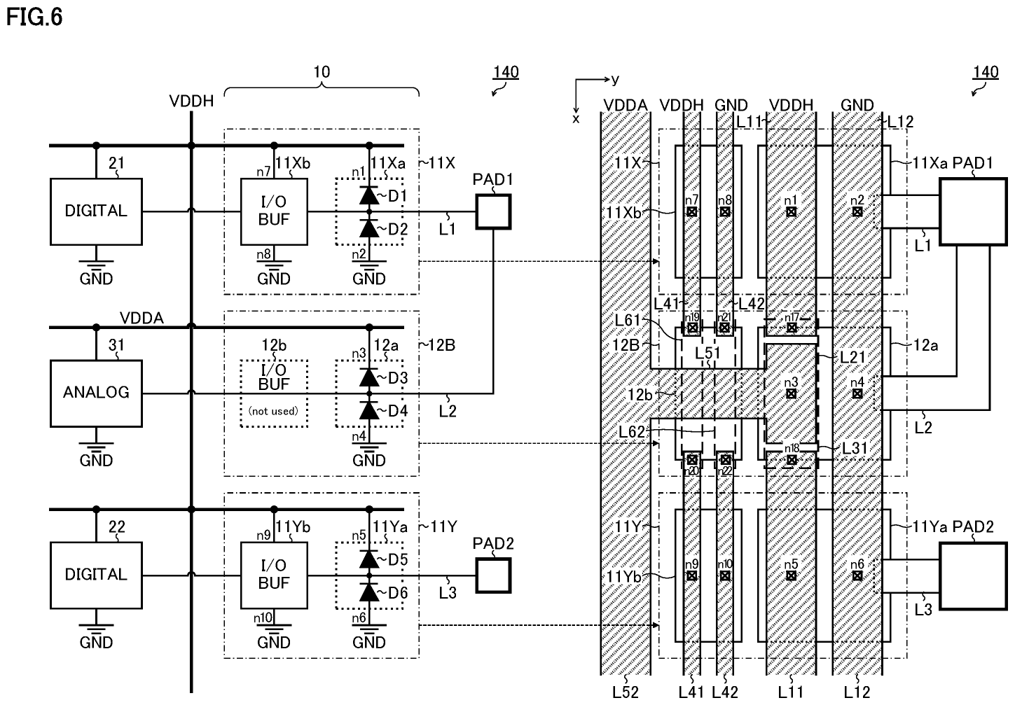

FIG. 6 is a diagram showing an I/O circuit 140 according to a second embodiment. As in FIGS. 2 to 5 referred to previously, at left in FIG. 6 is shown a schematic circuit diagram of the I/O circuit 140. On the other hand, at right in FIG. 6 is shown a schematic circuit layout of the I/O circuit 140 as seen on the xy plane.

The I/O circuit 140 of the second embodiment, while being based on the first comparative example (FIG. 5) described previously, is formed using an I/O cell 12B in place of the I/O cell 12A described previously. The I/O cell 12B has basically a similar configuration to the I/O cell 12A described previously, but further includes a power line L31 and power lines L61 and L62 (see long-stroke broken lines in FIG. 6).

The power line L31 (corresponding to a third power line) is formed so as to conduct to the power line L11 (corresponding to the first power line) while passing over or under the power line L21 (corresponding to the second power line) described previously.

In terms of what is shown in FIG. 6, the power lines L11 and L21 are arrayed, as seen on the xy plane, in the order of L11, L21, and L11 from top down in the diagram along a first direction x (up-down direction on the plane of the diagram) while keeping a distance from one another. The power line L31 is formed, in a wiring layer different from that of the power lines L11 and L21, so as to lie above or below the power lines L11 and L21 as seen on the xy plane. Then, the power lines L11 and L31 conduct to each other via nodes n17 and n18 (through contact holes, vias, or the like).

With this configuration, inside the I/O cell 12B, the parts of the power line L11 divided by the power line L21 can conduct to each other via the power line L31. Thus, the parts of the power lines L11 connected to the I/O cells 11X and 11Y respectively do not need to be reconnected together outside the I/O cell 12B, and this helps simplify the wiring layout.

A similar description applies to the power lines L61 and L62 (corresponding to a sixth power line); specifically, these can be formed so as to conduct respectively to the power lines L41 and L42 (corresponding to the fourth power line) while passing over or under the power line L51 (corresponding to the fifth power line) described previously. In terms of what is shown in FIG. 6, the power lines L41 and L61 conduct to each other via nodes n19 and n20 (through contact holes, vias, or the like). The power lines L42 and L62 conduct to each other via nodes n21 and n22 (through contact holes, vias, or the like).

With this configuration, inside the I/O cell 12B, the parts of the power line L41 and the parts of the power line L42 divided by the power line L51 can conduct via the power lines L61 and L62 respectively. Thus, the parts of the power lines L41 and L42 connected to the I/O cells 11X and 11Y respectively do not need to be reconnected outside the I/O cell 12B, and this helps simplify the wiring layout.

### I/O Circuit (Third Embodiment)

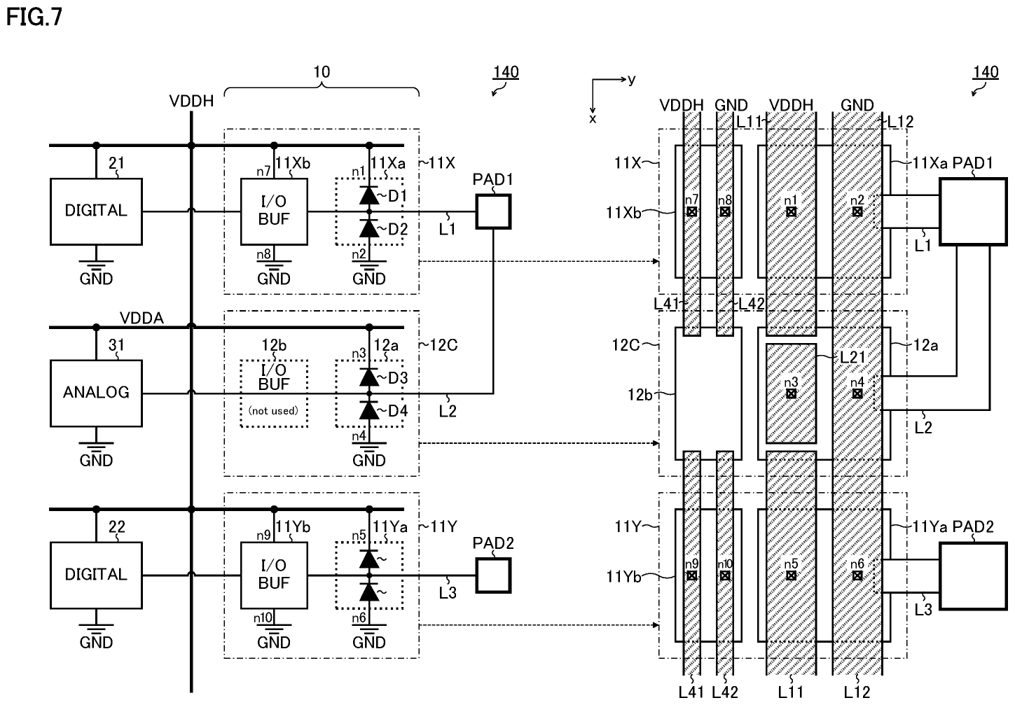

FIG. 7 is a diagram showing an I/O circuit 140 according to a third embodiment. As in FIGS. 2 to 6 referred to previously, at left in FIG. 7 is shown a schematic circuit diagram of the I/O circuit 140. On the other hand, at right in FIG. 7 is shown a schematic circuit layout of the I/O circuit 140 as seen on the xy plane.

The I/O circuit 140 of the third embodiment, while being based on the first comparative example (FIG. 5) described previously, is formed using an I/O cell 12C in place of the I/O cell 12A described previously.

The I/O cell 12C has basically a similar configuration to the I/O cells 12A and 12B described previously, but has, in a region over the I/O buffer 12b, a non-wiring region for laying the power line L51 described previously. That is, in a region over the I/O buffer 12b, the power lines L41 and L42 described previously are partly removed, and the vacant region is secured as it is as a region for laying the power line L51.

In this way, the power line L51 is not an essential circuit element of the I/O cell 12C; it is therefore possible to separately lay it after determining the outline of the I/O circuit 140 by freely combining a plurality of kinds of standard cells included in the I/O cell library 10.

<Overview>

To follow is an overview of the various embodiments described herein.

According to one aspect of what is disclosed herein, an I/O circuit is formed by freely combining a plurality of kinds of standard cells included in a cell library. The plurality of kinds of standard cells include at least a first standard cell and a second standard cell. The first standard cell includes a first protection element and a first power line formed in a region over the first protection element so as to conduct to the first protection element. The second standard cell includes a second protection element formed in a layout identical with the layout of the first protection element and a second power line formed in a region over the second protection element so as to conduct to the second protection element while being isolated from the first power line. (A first configuration.)

In the I/O circuit according to the first configuration described above, preferably, the plurality of kinds of standard cells are arrayed along a first direction, and the first power line is laid along the first direction. (A second configuration.)

In the I/O circuit according to the first or second configuration described above, preferably, the second standard cell further includes a third power line that is formed so as to conduct to the first power line while passing over or under the second power line. (A third configuration.)

In the I/O circuit according to the third configuration described above, preferably, the first standard cell further includes a first buffer or a first resistor formed so as to be connected to the first protection element and a fourth power line formed in a region over the first buffer or the first resistor. The second standard cell, preferably, further includes a second buffer or a second resistor formed in an identical layout with the layout of the first buffer or the first resistor so as to be connected to the second protection element. (A fourth configuration.)

In the I/O circuit according to the fourth configuration described above, preferably, in a region over the second buffer or the second resistor is provided a fifth power line formed so as to conduct to the second power line while being isolated from the fourth power line or a non-wiring region for forming the fifth power line. (A fifth configuration.)

In the I/O circuit according to the fourth or fifth configuration described above, preferably, the first buffer and the second buffer are each an input buffer, an output buffer, or an input/output buffer. (A sixth configuration.)

According to another aspect of what is disclosed herein, a semiconductor device includes: the I/O circuit according to any of the first to sixth configurations described above; a first internal circuit that is connected to the first standard cell and that is configured to receive electric power from the first power line; and a second internal circuit that is connected to the second standard cell and that is configured to receive electric power from the second power line. (A seventh configuration.)

The semiconductor device according to the seventh configuration described above, preferably, further includes a pad configured to have the first and second standard cells both connected to it. (An eighth configuration.)

According to yet another aspect of what is disclosed herein, a cell library is read from a circuit design program executed on a computer and includes a plurality of kinds of standard cells that can be freely combined to form an I/O circuit in a semiconductor device. The plurality of kinds of standard cells include at least a first standard cell and a second standard cell. The first standard cell includes a first protection element and a first power line formed in a region over the first protection element so as to conduct to the first protection element. The second standard cell includes a second protection element formed in a layout identical with the layout of the first protection element and a second power line formed in a region over the second protection element so as to conduct to the second protection element while being isolated from the first power line. (A ninth configuration.)

According to still another aspect of what is disclosed herein, a method of designing a circuit of a semiconductor device using the cell library according to the ninth configuration described above includes: a step of selecting, arranging, and freely combining the plurality of kinds of standard cells included in the cell library; and a step of laying power lines and signal lines so as to connect the plurality of kinds of freely combined standard cells to other circuit blocks. (A tenth configuration.)

### Further Modifications

The various technical features disclosed herein may be implemented in any other manners than in the embodiments described above, and allow for any modifications made without departure from their technical ingenuity. That is, the above embodiments should be understood to be in every aspect illustrative and not restrictive. The scope of the present invention is defined not by the description of the embodiments given above but by the appended claims, and should be understood to encompass any modifications made in a sense and scope equivalent to those of the claims.

1. An I/O circuit formed by freely combining a plurality of kinds of standard cells included in a cell library,
wherein
the plurality of kinds of standard cells include at least a first standard cell and a second standard cell,
the first standard cell includes
a first protection element and
a first power line formed in a region over the first protection element so as to conduct to the first protection element, and
the second standard cell includes
a second protection element formed in a layout identical with a layout of the first protection element and
a second power line formed in a region over the second protection element so as to conduct to the second protection element while being isolated from the first power line.

2. The I/O circuit according to claim 1,
wherein
the plurality of kinds of standard cells are arrayed along a first direction, and
the first power line is laid along the first direction.

3. The I/O circuit according to claim 1,
wherein
the second standard cell further includes a third power line that is formed so as to conduct to the first power line while passing over or under the second power line.

4. The I/O circuit according to claim 3,
wherein
the first standard cell further includes
a first buffer or a first resistor formed so as to be connected to the first protection element and
a fourth power line formed in a region over the first buffer or the first resistor, and
the second standard cell further includes a second buffer or a second resistor formed in an identical layout with a layout of the first buffer or the first resistor so as to be connected to the second protection element.

5. The I/O circuit according to claim 4,
wherein
in a region over the second buffer or the second resistor is provided
a fifth power line formed so as to conduct to the second power line while being isolated from the fourth power line or
a non-wiring region for forming the fifth power line.

6. The I/O circuit according to claim 4,
wherein
the first buffer and the second buffer are each an input buffer, an output buffer, or an input/output buffer.

7. A semiconductor device comprising:
the I/O circuit according to claim 1;
a first internal circuit connected to the first standard cell, the first internal circuit being configured to receive electric power from the first power line; and
a second internal circuit connected to the second standard cell, the second internal circuit being configured to receive electric power from the second power line.

8. The semiconductor device according to claim 7, further comprising a pad configured to have the first and second standard cells both connected thereto.

9. A cell library read from a circuit design program executed on a computer, the cell library comprising a plurality of kinds of standard cells that are freely combinable to form an I/O circuit in a semiconductor device,
wherein
the plurality of kinds of standard cells include at least a first standard cell and a second standard cell,
the first standard cell includes
a first protection element and
a first power line formed in a region over the first protection element so as to conduct to the first protection element, and
the second standard cell includes
a second protection element formed in a layout identical with the layout of the first protection element and
a second power line formed in a region over the second protection element so as to conduct to the second protection element while being isolated from the first power line.

10. A method of designing a circuit of a semiconductor device using the cell library according to claim 9, comprising:
a step of selecting, arranging, and freely combining the plurality of kinds of standard cells included in the cell library; and
a step of laying power lines and signal lines so as to connect the plurality of kinds of freely combined standard cells to other circuit blocks.
